(19) United States
(12) Patent Application Publication
(10) Pub. No.: US 2013/0283099 A1
(43) Pub. Date: Oct. 24, 2013

(54) SYSTEM AND METHOD FOR TESING STABILITY OF SERVER

(71) Applicants: JIA-QING HUANG, Shenzhen City (CN); ZHAO-YANG CAI, Shenzhen City (CN); ZHENG-QUAN PENG, Shenzhen City (CN); YI-XIN TU, Shenzhen City (CN); HAI-QING ZHOU, Shenzhen City (CN)

(72) Inventors: JIA-QING HUANG, Shenzhen City (CN); ZHAO-YANG CAI, Shenzhen City (CN); ZHENG-QUAN PENG, Shenzhen City (CN); YI-XIN TU, Shenzhen City (CN); HAI-QING ZHOU, Shenzhen City (CN)

(73) Assignees: HON HAI PRECISION INDUSTRY CO., LTD., Tu-cheng (TW); HON FU JIN PRECISION INDUSTRY (ShenZhen) CO., LTD., Shenzhen City (CN)

(21) Appl. No.: 13/563,764

(22) Filed: Aug. 1, 2012

(30) Foreign Application Priority Data
Apr. 23, 2012 (CN) 201210120232.1

(51) Int. Cl. G06F 11/28

(52) U.S. Cl. 714/32; 714/E11.178

(57) ABSTRACT

A method for testing stability of a server includes the following steps. Providing a first user input interface for a user to input test parameters. Generating a control signal according to the input test parameters and transmitting the control signal to the BMC of the server. Controlling the server to start and shut down via the BMC. Detecting whether the tested characteristics are within specified ranges during each start and shutting down operation. Generating a SEL if any abnormal result is obtained and records a test time when the abnormal result is obtained in the SEL. Storing the generated SEL in a storage unit. Providing a second user input interface on the display for the user to input conditions to filter test results. And responding to the input conditions and outputting corresponding test results to the display.

### BACKGROUND

1. Technical Field

The present disclosure relates to testing systems, and particularly, to a system and a method for testing the stability of a server.

2. Description of Related Art

Stability testing of servers can be performed by controlling the server to repeatedly start and shut down while monitoring system status of the server. To perform such testing, a peripheral device is connected to the server and configured to control the server to repeatedly start and shut down. During each start/shut down operation, a baseboard management controller (BMC) located in the server utilizes sensors to monitor various working conditions of firmware and hardware of the server, such as fan speed, microprocessor temperature, and so forth, and records any abnormal working conditions in a system event log (SEL). Thus, the stability of the server can be determined by examining the SEL. However, this type of peripheral device increases the expense of stability testing.

Therefore, what is needed is a means to solve the problems described above.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of a system for testing stability of a server, in accordance with an exemplary embodiment.

FIG. 2 is a block diagram of a system for testing stability of a server, in accordance with another exemplary embodiment.

FIG. 3 is a flowchart of a method for testing stability of a server, in accordance with an exemplary embodiment.

### DETAILED DESCRIPTION

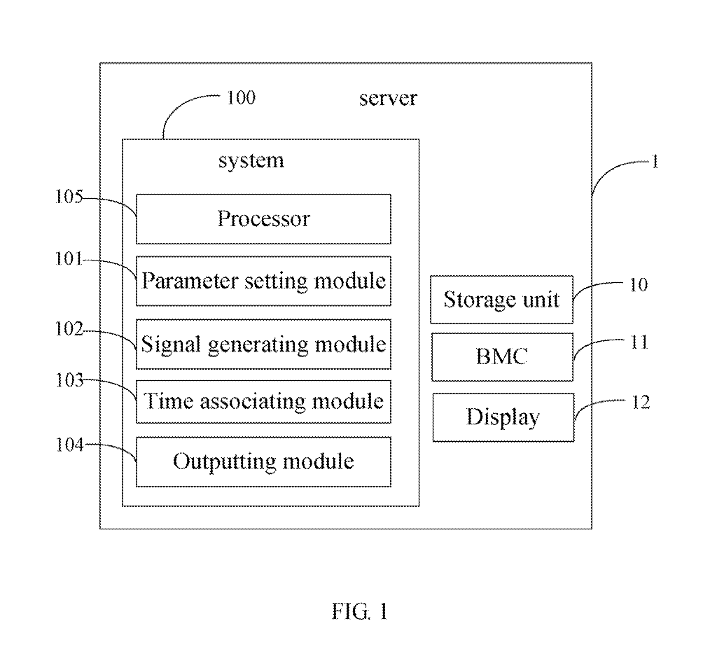

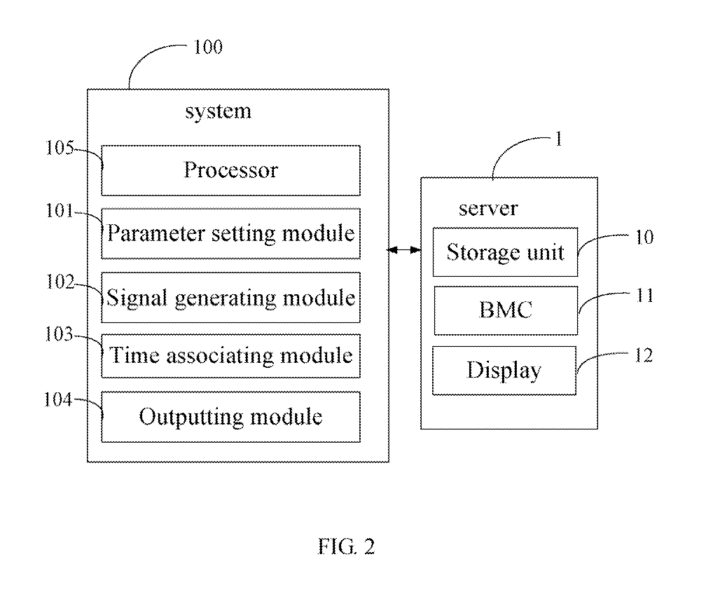

FIGS. 1-2 are block diagrams of a system 100 for testing stability of a server 1 according to different exemplary embodiments. Referring to FIG. 1, in the embodiment, the system 100 is installed in the server 1. The server 1 includes a storage unit 10, a BMC 11, and a display 12. The system 100 can communicate with the BMC 11, and control the server 1 to periodically start and shut down via the BMC 11. Referring to FIG. 2, in an alternative embodiment, the system 100 may be an auto-running application applied to a removable storage device, such as a mobile hard disk or a USB disk, and may perform the corresponding functions when the removable storage device is connected to the server 1.

The system 100 includes a processor 105 and a variety of modules executed by the processor 105 to provide the functions of the system 100. The variety of modules includes a parameter setting module 101, a signal generating module 102, a time associating module 103, and an outputting module 104.

The parameter setting module 101 provides a first user input interface on the display 12 for a user to input test parameters via an input device such as a keyboard. The test parameters include start/shutting down parameters and characteristics to be tested. In the embodiment the start/shutting down parameters include the total times that the server 1 is started/shut down during the test, and the time interval between each two times the server 1 is started/shut down. For example, through the parameter setting module 101, the user may set the number of the times that the server 1 is started/shut down to be 1000, and set the time interval that the server 1 is started/shut down to be 2 seconds. The tested characteristics may include fan speed, the voltage and the temperature of the server 1, and so forth.

The signal generating module 20 generates a control signal according to the test parameters input by the user and then transmits the control signal to the BMC 11. The BMC 11 responds to the control signal, controls the server 1 to execute start/shutting down operations according to the start/shutting down parameters, detects whether the tested characteristics are within specified ranges during each start/shutting down operation, generates a SEL if any abnormal result is obtained and records the test time when the abnormal result is obtained in the SEL, and then stores the generated SEL in the storage unit 10.

The parameter setting module 101 further provides a second user input interface on the display 12 for the user to input a condition to filter test results. In the embodiment, the input condition includes at least one tested characteristic, for example, if the user wants to easily read just the test results regarding abnormal temperatures of the server 1 and what time the abnormal temperatures occurred that have been recorded in an SEL. In an alternative embodiment, the input condition may include a time period, for example, if the user wants to easily read just the test results occurred within the input time period. The corresponding test results then are outputted by the outputting module 104 to the display 12.

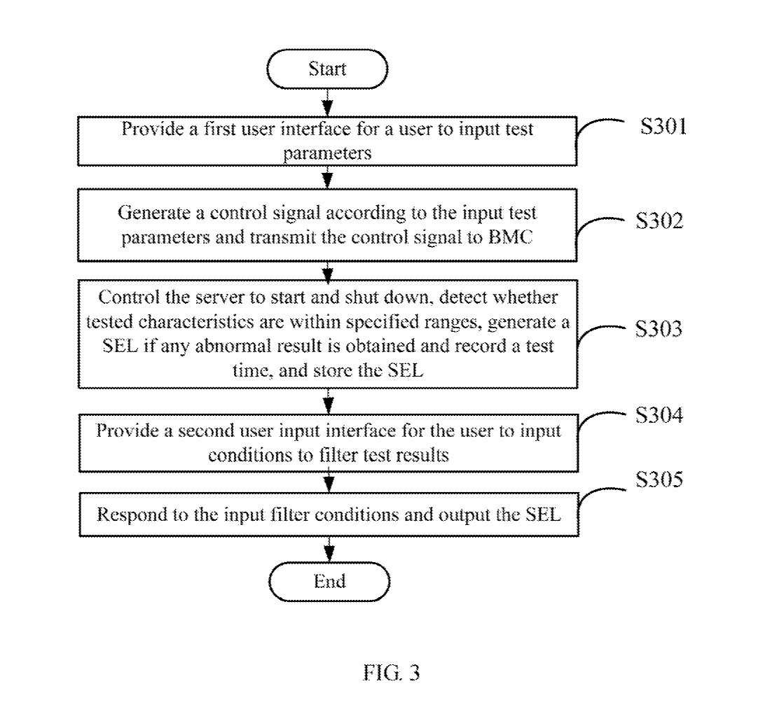

FIG. 3 is a flowchart of a method for testing stability of a server 1, in accordance with an exemplary embodiment.

In step S301, through an input device, the user inputs test parameters on the first user input interface provided by the parameter setting module 101, and the input test parameters includes start/shutting down parameters and tested characteristics.

In step S302, the signal generating module 20 generates a control signal according to the test parameters input by the user and transmits the control signal to the BMC 11.

In step S303, the BMC 11 responds to the control signal, control the server 1 to execute start/shutting down operations according to the start/shutting down parameters, detects whether the tested characteristics are within specified ranges during each start/shutting down operation, generates a SEL if any abnormal result is obtained and records the test time the abnormal result is obtained in the SEL, and then stores the generated SEL in the storage unit 10.

In step S304, through the input device, the user inputs conditions to filter test results on the second user input interface provided by the parameter setting module 101.

In step S305, the outputting module 104 outputs the corresponding test results to the display 12.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system configured for testing stability of a server, the server comprising a baseboard management controller, the system comprising:
a processor; and
a plurality of modules executed by the processor, the plurality of modules comprising:
a parameter setting module to provide a first user input interface on a display of the server for a user to input test parameters and provide a second user input interface on the display for the user to input conditions to filter test results, wherein the test parameters comprise start and shutting down parameters and tested characteristics;
a signal generating module to generate a control signal according to the input test parameters and transmit the control signal to the baseboard management controller, the control signal configured to direct the baseboard management controller to start and shut down the server according to the start and shutting down parameters, such that the baseboard management controller detects whether the tested characteristics are within specified ranges during each start and shutting down operation, generates a system event log if any abnormal result is obtained and records a test time when the abnormal result is obtained in the system event log, and stores the generated system event log in a storage unit; and
an outputting module to respond to the input conditions and output corresponding test results to the display.

2. The system of claim 1, wherein the start and shut down parameters comprise a total time that the server is started and shut down during the test, and a time interval between each two times the server is started and shut down.

3. The system of claim 1, wherein the input condition comprises at least one tested characteristic; and the outputting module is configured to output test results of the input tested characteristic and the test time the test results are obtained.

4. The system of claim 1, wherein the input condition comprises at least one time period; and the outputting module is configured to output test results obtained within the input time period.

5. A method for testing stability of a server, the server comprising a baseboard management controller, the method comprising:
providing a first user input interface on a display of the server for a user to input test parameters, wherein the test parameters comprise start and shutting down parameters and tested characteristics;
generating a control signal according to the input test parameters and transmitting the control signal to the baseboard management controller, the control signal configured to direct the baseboard management controller to start and shut down the server according to the start and shutting down parameters, such that the baseboard management controller detects whether the tested characteristics are within specified ranges during each start and shutting down operation, generates a system event log if any abnormal result is obtained and records a test time when the abnormal result is obtained in the system event log, and stores the generated system event log in a storage unit;
providing a second user input interface on the display for the user to input conditions to filter test results; and
responding to the input conditions and outputting corresponding test results to the display.

6. The method of claim 5, wherein the start and shut down parameters comprise a total time that the server is started and shut down during the test, and a time interval between each two times the server is started and shut down.
